(19) United States
(12) Patent Application Publication
(10) Pub. No.: US 2005/0221142 A1
(43) Pub. Date: Oct. 6, 2005

(54) Composite polymer electrolytes based on organosilica hybrid proton conductors for fuel cells

(76) Inventors: Sekharipuram R. Narayanan, Arcadia, CA (US); Shiao-Pin S. Yen, Altadena, CA (US)

Correspondence Address: CHRISTIE, PARKER & HALE, LLP, PO BOX 7068, PASADENA, CA, 91109-7068, US

(21) Appl. No.: 11/088,060

(22) Filed: Mar. 23, 2005

Related U.S. Application Data
(60) Provisional application No. 60/555,627, filed on Mar. 23, 2004.

(51) Int. Cl. H01M 8/10

(52) U.S. Cl. 429/33; 252/182.1

(57) ABSTRACT

Composite polymer electrolytes for use in Polymer Electrolyte Membrane (PEM) fuel cells are disclosed. The electrolytes comprise sulfonated-organosilica hybrid electrolyte materials formed into a membrane. The sulfonated-organosilica hybrid electrolyte materials may be formed into a membrane by combining them in solution with Nafion® and solution casting the solution slurry to form a membrane. Alternatively, the sulfonated-organosilica hybrid electrolyte materials may be formed into a membrane by mixing them with an appropriate binder and applying the mixture to a suitable substrate. Also, the sulfonated-organosilica hybrid electrolyte materials may be formed into a membrane by sheer calendaring a co-precipitate of the sulfonated-organosilica hybrid electrolyte materials and Teflon®.

### CROSS-REFERENCE TO RELATED APPLICATION(S)

This application claims priority of Provisional Application Ser. No. 60/555,627, filed Mar. 23, 2004, entitled COMPOSITE POLYMER ELECTROLYTES BASED ON ORGANOSILICA HYBRID PROTON CONDUCTORS, the entire content of which is incorporated herein by reference.

### FIELD OF THE INVENTION

This invention is directed to composite polymer electrolytes for use in fuel cells, and to fuel cells employing such electrolytes.

### BACKGROUND OF THE INVENTION

A typical fuel cell comprises an anode, a cathode and an electrolyte. There are several types of fuel cells, including polymer electrolyte membrane fuel cells, direct methanol fuel cells and solid oxide fuel cells, among others. Polymer electrolyte membrane (PEM) fuel cells typically operate at low temperatures, for example, at temperatures below about 80° C. This low temperature operation makes PEM fuel cells particularly desirable because the materials used in the fuel cells are less expensive and easier to manage. Accordingly, PEM fuel cells have been heavily researched for use in transportation applications.

However, the low operation temperatures are close to the ambient temperature, making the efficient rejection of heat to the environment quite challenging. In addition, PEM fuel cells operate on complex fuels such as natural gas, methanol or gasoline and employ fuel processors which process these fuels into hydrogen. The processed fuels contain significant amounts of carbon monoxide in addition to the generated hydrogen. This carbon monoxide poisons the fuel cell catalysts. Fuel cells operating at temperatures below about 100° C. have relatively low carbon monoxide tolerance. However, fuel cells operating at temperatures above about 120° C. have much higher carbon monoxide tolerance. Accordingly, while PEM fuel cells operating at lower temperatures remain useful, PEM fuel cells capable of operation at higher temperatures are desired for transportation applications. Such PEM fuel cells are also desirable for distributed energy generation applications and small portable devices.

PEM fuel cells, as their name suggests, employ polymers as the electrolytes. One such widely used polymer electrolyte is Nafion®, a perfluorinated ionomeric membrane. The wide use of Nafion® as the electrolyte in PEM fuel cells is attributed to the polymer's excellent stability, high ionic conductivity and mechanical strength. However, Nafion® electrolytes depend highly on the presence of water for proton conduction, and can only be employed in fuel cells operated at temperatures below 100° C. When fuel cells having Nafion® electrolytes are operated at temperatures above 100° C., the Nafion® membranes lose water readily, become dry, and develop cracks in the membranes. Because Nafion® requires water for proton conduction, the Nafion® membranes lose their conducting properties when water is lost.

As noted above, PEM fuel cells are advantageously operated at higher temperatures, specifically at temperatures above 120° C. Operation at these higher temperatures imparts significant benefits such as improved cell and system performance. Accordingly, a need exists for alternate electrolyte membranes capable of withstanding these high temperatures.

Recently, polymeric quaternized amine salts, as a class of materials, has been proposed as an alternative to Nafion® membranes for operation at higher temperatures. Poly-4-vinylpyridinium salts are examples of such materials. Although these materials have stable proton conductivity of between 10⁻² to 10⁻³ S/cm at temperatures between 130 and 180° C., higher conductivity and operating temperatures are desired to attain fuel cells with high power densities for transportation applications. Furthermore, the proton conductivity of these materials is significantly less at ambient temperatures, thereby limiting the applications with which they can be used. Therefore, a need still exists for alternative polymer electrolytes for use in fuel cells operated over a wide temperature range, including both low and high temperature operation.

### SUMMARY OF THE INVENTION

The present invention is directed to alternative polymer electrolytes for use with polymer electrolyte membrane (PEM) fuel cells. The electrolytes of the invention comprise membranes of sulfonated-organosilica hybrid electrolyte particles. The sulfonated-organosilica hybrid electrolyte materials are ideal for use as electrolytes in PEM fuel cells, but must first be formed into a membrane for such use.

In one embodiment, the sulfonated-organosilica hybrid electrolyte materials are formed into a membrane by mixing them in solution with Nafion®. The solution slurry is then solution cast to form a membrane. The combination of sulfonated-organosilica hybrid electrolyte materials and Nafion® increases the possible temperature of operation for a fuel cell employing such an electrolyte. A fuel cell employing this composite electrolyte can perform well over a wide range of temperatures, for example, from below about 40° C. to about 125° C.

In another embodiment, the sulfonated-organosilica hybrid electrolyte materials are formed into a membrane by mixing them with an appropriate binder in solution and applying the mixture to a suitable substrate. The solution and substrate are then rolled or otherwise smoothed to form a smooth membrane. Upon rolling or otherwise smoothing the substrate, the sulfonated-organosilica hybrid electrolyte particles are completely impregnated into holes in the substrate, creating a gas impermeable, smooth layer of sulfonated-organosilica hybrid electrolyte particles.

In yet another embodiment, the sulfonated-organosilica hybrid electrolyte materials are formed into a membrane by first suspending the materials in a solution of Teflon® latexes. The Teflon® and the sulfonated-organosilica hybrid electrolyte materials co-precipitate out and the resulting co-precipitate is then sheer calendared to form a membrane. Upon sheer calendaring the co-precipitate, the Teflon® forms an irregular woven mesh structure comprising holes into which the sulfonated-organosilica hybrid electrolyte particles are forced. This creates a membrane having a surface of sulfonated-organosilica hybrid electrolyte particles.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic depicting a process for making an electrolyte membrane according to one embodiment of the present invention;

FIG. 2 is an enlarged, close-up view of an electrolyte membrane according to one embodiment of the present invention; and

FIG. 3 is a schematic depicting a fuel cell according to one embodiment of the present invention.

### DETAILED DESCRIPTION OF THE INVENTION

The present invention is directed to composite polymer electrolyte membranes for use in polymer electrolyte membrane (PEM) fuel cells, such as hydrogen/oxygen fuel cells, including direct methanol fuel cells. Although the electrolytes of the present invention are described with reference to PEM fuel cells, it is understood that they may be used in any hydrogen/oxygen fuel cell, molten salt fuel cell operated below about 200° C., and in direct methanol fuel cells.

The electrolytes of the present invention employ hybrid inorganic polyelectrolytes which either depend on water or no water for proton conduction. The inorganic polyelectrolytes preferably comprise siloxyl-substituted aromatics having sulfonic acid groups. Preferred aromatics comprise sulfonated-organosilica hybrid electrolyte materials, such as those disclosed in Inagaki, Shinji, “An Ordered Mesoporous Organosilica Hybrid Material with a Crystal-like Wall Structure,” Nature, vol. 416, pps. 304-307 (Mar. 21, 2002), the entire disclosure of which is incorporated herein by reference. These sulfonated-organosilica hybrid materials are nano-particulates and have high conductivity. They are prepared, for example, by the alkaline hydrolysis of 1,4-bis(triethoxysilyl)benzene in a surfactant-containing medium. The organosilica hybrid materials prepared according to this process have an ordered mesoporous structure held together by a network of silicon-oxygen bonds.

To form the electrolytes useful with the present invention, the benzene moiety of the organosilica hybrid structure is sulfonated, which sulfonation yields a sulfonic acid derivative that is stable up to about 500° C. The sulfonated organosilica hybrid behaves substantially like a strong acid and has the following chemical structure:

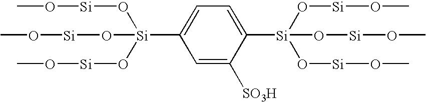

Although the material shown above shows sulfonation of only the benzene ring, the siloxyl groups may also be sulfonated. When the siloxyl groups are sulfonated, the sulfonated-organosilica hybrid electrolyte material does not depend on water for proton conduction, because the material is more acidic. These sulfonated-organosilica hybrid electrolyte materials are ideal for use as electrolytes for fuel cells operating at temperatures both below 100° C. when there is available water, and above 100° C. due to the availability of mobile protons, the strong tendency of silica to retain water, the possibility of forming hydrogen bonds, and good thermal stability. However, these materials are in powder form. In order to use these materials as electrolytes for fuel cells, they must be formed into a membrane. To form these materials into a membrane, the particles of the sulfonated-organosilica hybrid electrolyte materials are combined with a suitable carrier for carrying the particles.

In one embodiment of the present invention, the carrier comprises a Nafion® solution. The above-described sulfonated-organosilica hybrid electrolyte materials are formed into a membrane by mixing them with Nafion® and solution casting the mixture to form a membrane. The mixture of the sulfonated-organosilica hybrid electrolyte and Nafion® can comprise between about 10 and 80 wt % Nafion®, depending on the molecular weight of the Nafion®.

The combination of the sulfonated-organosilica hybrid electrolyte materials with Nafion® enables use of the sulfonated-organosilica hybrid electrolyte materials as a membrane for a fuel cell. The sulfonated-organosilica hybrid electrolyte materials, like Nafion®, require water for proton conduction. However, the sulfonated-organosilica hybrid electrolyte materials exhibit much better water retention than Nafion® at higher temperatures. Although Nafion® will lose water at temperatures above 100° C., the membrane will remain useful at higher temperatures due to the excellent water retention of the sulfonated-organosilica hybrid electrolyte materials. In addition, this composite electrolyte, when containing sulfonated siloxyl groups, works well at higher temperatures because the protons are close to each other, being separated only by a siloxyl group, enabling proton hopping without water.

However, at temperatures above about 125° C., the sulfonated-organosilica hybrid electrolyte materials also lose water, adversely affecting the conductivity of the electrolyte. Accordingly, while these composite electrolytes work well in fuel cells operated at low temperatures as well as at temperatures up to about 125° C. or higher, the electrolyte does not work significantly well in fuel cells operated beyond 125° C.

In an alternative embodiment, the carrier comprises a suitable substrate. In this embodiment, the sulfonated-organosilica hybrid electrolyte materials are formed into a membrane by mixing them with a suitable binder, applying the mixture to the substrate to form a membrane construction, and rolling or otherwise smoothing the construction to form a gas impermeable, smooth membrane.

Any suitable binder may be used. Preferably, however, the binder comprises a high molecular weight, high viscosity, proton conducting, polymeric binder. Such a binder preferably has a weight average molecular weight of at least about 40,000 and not greater than about 500,000. The polymeric binder also preferably comprises a polymer that is quaternizable to form either hydrogen sulfate, hydrogen phosphate or sulfonic acid salts of aromatic polyetheretherketone or aromatic polyether sulfone, and that is soluble in water. Nonlimiting examples of suitable binders include poly-4-vinyl pyridine hydrogen sulfate, poly-4-vinyl pyridine hydrogen phosphate, poly-2-methyl-5-vinyl pyridine hydrogen sulfate, poly-2-methyl-5-vinyl pyridine hydrogen phosphate and sulfonic acid salts of aromatic polyetheretherketone or aromatic polyether sulfone. The binder is preferably present in the mixture in an amount ranging from about 1 to about 10 wt %. The binder can be cross-linked by heating, thereby rendering the sulfonated-organosilica hybrid material and binder mixture insoluble in water.

The substrate on which the mixture of the sulfonated-organosilica hybrid electrolyte materials and the binder is applied preferably comprises a lightweight substrate having high temperature resistance and stability. Nonlimiting examples of suitable substrates include light, non-woven paper including polybenzimidazole, polybenzoxazole and glass. For example, the substrate may comprise 10 g/m² polybenzoxazole. Although glass may be used as a substrate, it is significantly heavier than polybenzimidazole and polybenzoxazole. Polybenzimidazole and polybenzoxazole are therefore preferred over glass for use as the substrate. In addition, non-woven polybenzimidazole or polybenzoxazole paper is preferred.

In applying the sulfonated-organosilica hybrid electrolyte materials to the substrate, enough of the powder-binder mixture is used to completely cover the surface of the substrate to prevent gas permeation. In particular, enough of the powder-binder mixture is used such that all the pores in the substrate are covered. When the construction is subsequently rolled or otherwise smoothed, the powder-binder mixture is impregnated into the pores in the substrate, creating a surface of bare sulfonated-organosilica hybrid electrolyte particles.

The electrolyte according to this embodiment enables operation of the fuel cell at much higher temperatures. For example, the polybenzimidazole substrate is stable up to about 450° C. Similarly, the polybenzoxazole substrate is stable up to about 600° C.

In yet another embodiment of the present invention, the carrier comprises Teflon® latexes suspended in solution. In this embodiment, the sulfonated-organosilica hybrid electrolyte powder is added to the Teflon® latex suspension. The sulfonated-organosilica hybrid electrolyte particles and Teflon® co-precipitate out of the solution. The co-precipitate is then sheer calendared to form a membrane. Teflon® is preferably present in the co-precipitate in an amount ranging from about 3 to about 13 wt %. More preferably, Teflon® is present in the co-precipitate in an amount ranging from about 3 to about 10 wt %. Even more preferably, Teflon® is present in the co-precipitate in an amount ranging from about 5 to about 6 wt %.

The electrolyte according to this embodiment also enables operation of the fuel cell at temperatures higher than embodiments utilizing Nafion®. The Teflon® binder is stable below about 300° C.

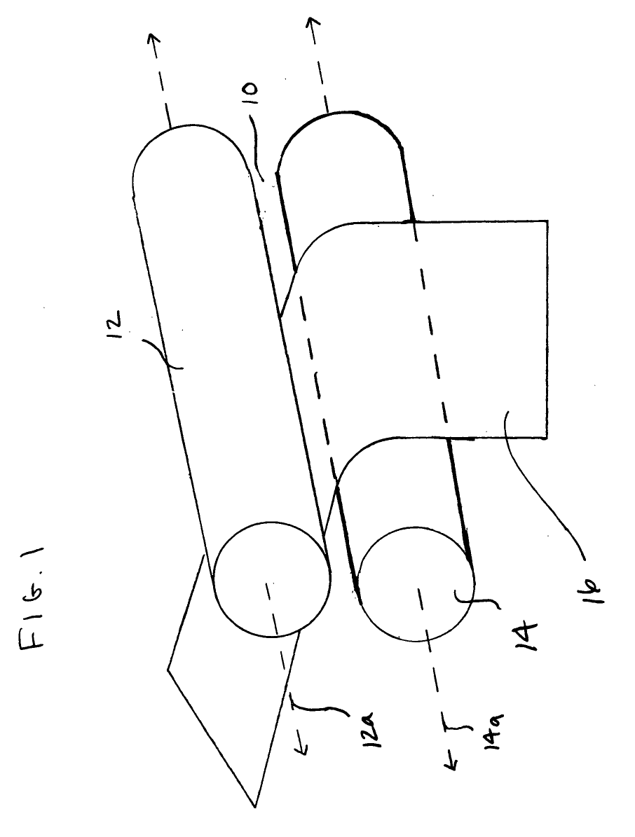

The sheer calendaring process for creating a composite membrane of Teflon® and the sulfonated-organosilica hybrid electrolyte material, as shown in FIG. 1, comprises forcing the co-precipitate through a narrow passage 10 between a first roller 12 and a second roller 14. The first and second rollers 12 and 14, respectively, are cylindrical in shape. The first roller 12 is positioned on top of the second roller 14, and rotates in a first direction about an axis 12a. The second roller 14 rotates in a second direction, opposite the first direction, about an axis 14a. The co-precipitate 16 of Teflon® and the sulfonated-organosilica hybrid electrolyte is forced through the narrow passage 10 between the rollers 12 and 14. The rotation of the rollers 12 and 14 forces the co-precipitate 16 through the narrow passage 10.

After forcing the co-precipitate 16 through the narrow passage 10, the narrow passage 10 is narrowed, to form an even narrower passage. The co-precipitate 16 is then forced through the narrower passage a second time. This process, namely the narrowing of the passage 10, and the forcing of the co-precipitate 16 through the passage 10, is repeated several times until the co-precipitate 16 forms a uniform gas impermeable membrane.

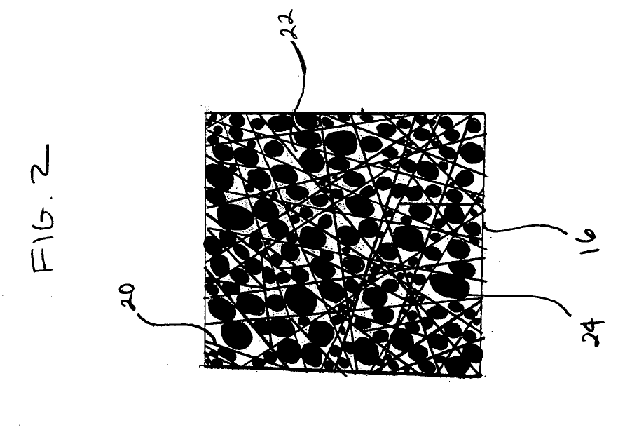

Upon forcing the co-precipitate 16 through the narrow passage 10 the first time, the Teflon® in the co-precipitate 16 forms an irregular non-woven fibrous structure 20 comprising several holes 22, as shown in FIG. 2. FIG. 2 is used for illustration purposes only, and is not drawn to scale. When the construction 19 is forced through the narrow passage 10, the sulfonated-organosilica hybrid electrolyte particles 24 are forced into the holes 22 in the Teflon® structure 24, thereby impregnating the Teflon® 20 with the sulfonated-organosilica hybrid electrolyte particles 24. After forcing the co-precipitate 16 through the passage 10 several more times, the fibrous Teflon® structure continues to flatten, and the sulfonated-organosilica hybrid electrolyte particles continue to spread into the holes 22 in the Teflon® structure 20. As noted above, this process creates a uniform, gas impermeable membrane having no holes.

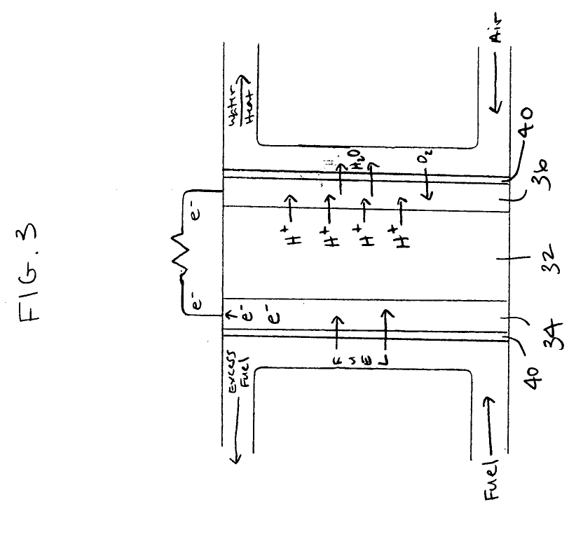

As shown in FIG. 3, a fuel cell 30 utilizing an electrolyte according to the present invention comprises an anode 34, a cathode 36 and a composite polymer electrolyte 32. The operation of fuel cells, including the operation of polymer electrolyte fuel cells, is well known. However, in general, the anode 34 electrochemically oxidizes the fuel (e.g. H₂), producing electrons which travel through an external circuit to the cathode 36. The composite polymer electrolyte 32 conducts protons from the anode 34 to the cathode 36 to maintain the internal circuit of the fuel cell 30. The protons and electrons are then consumed by the oxygen at the cathode 36 in a reduction reaction. The protons, electrons and oxygen gather at the cathode 36 and form water. Preferably, the anode 34 and the cathode 36 each comprise a catalyst 40 for catalyzing the oxidation of the fuel. Any known catalyst 40 may be used, for example, Pt, Pt/Ru and Pt/Sn.

The preceding description has been presented with reference to the presently preferred embodiments of the invention. Workers skilled in the art and technology to which this invention pertains will appreciate that alterations and modifications may be made to the described embodiments without meaningfully departing from the principal, spirit and scope of this invention. Accordingly, the foregoing description should not be read as pertaining only to the precise embodiments described, but rather should be read as consistent with, and as support for, the following claims, which are to have their fullest and fairest scope.

1. An electrolyte for use in a fuel cell, the electrolyte comprising:
a membrane comprising:
a quantity of particles of a sulfonated-organosilica hybrid electrolyte material having the general formula: 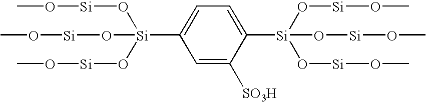
and
a carrier for carrying said particles.

2. An electrolyte according to claim 1, wherein the carrier comprises Nafion®.

3. An electrolyte according to claim 2, wherein the sulfonated-organosilica hybrid electrolyte particles are suspended in a solution of Nafion®, and Nafion® is present in the solution in an amount ranging from about 10 to about 80 wt %.

4. An electrolyte according to claim 1, wherein the carrier is a substrate selected from the group consisting of papers of glass, polybenzimidazole and polybenzoxazole.

5. An electrolyte according to claim 1, wherein the carrier is a substrate selected from the group consisting of polybenzimidazole and polybenzoxazole.

6. An electrolyte according to claim 5, wherein the membrane further comprises a binder.

7. An electrolyte according to claim 6, wherein the binder comprises a polymeric binder having a weight average molecular weight ranging from about 40,000 to about 500,000.

8. An electrolyte according to claim 6, wherein the binder comprises a polymer quaternizable to form a material selected from the group consisting of hydrogen sulfate, hydrogen phosphate, sulfonic acid salts of aromatic polyetheretherketone, and sulfonic acid salts of aromatic polyether sulfone.

9. An electrolyte according to claim 6, wherein the binder is selected from the group consisting of poly-4-vinyl pyridine hydrogen phosphate, poly-4-vinyl pyridine hydrogen sulfate, poly-2-methyl-5-vinyl pyridine hydrogen phosphate, poly-2-methyl-5-vinyl pyridine hydrogen sulfate, sulfonic acid salts of aromatic polyetheretherketone, and sulfonic acid salts of aromatic polyether sulfone.

10. An electrolyte according to claim 1, wherein the carrier comprises a quantity of Teflon® latexes.

11. An electrolyte according to claim 10, wherein the Teflon® latexes are present in an amount ranging from about 3 to about 13 wt %.

12. An electrolyte according to claim 10, wherein the Teflon® latexes are present in an amount ranging from about 3 to about 10 wt %.

13. An electrolyte according to claim 10, wherein the Teflon® latexes are present in an amount ranging from about 5 to about 6 wt %.

14. An electrolyte for use in a fuel cell, the electrolyte comprising:
a membrane comprising:
a quantity of particles of a sulfonated-organosilica hybrid electrolyte material having the general formula: 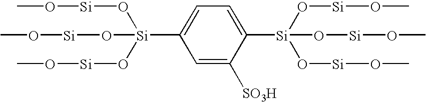
and
a quantity of Nafion®.

15. An electrolyte according to claim 14, wherein the sulfonated-organosilica hybrid electrolyte particles are suspended in a solution of Nafion®, and Nafion® is present in the solution in an amount ranging from about 10 to about 80 wt %.

16. An electrolyte for use in a fuel cell, the electrolyte comprising:
a membrane comprising:
a quantity of particles of a sulfonated-organosilica hybrid electrolyte material having the general formula: 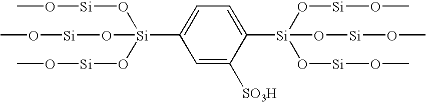
and
a substrate selected from the group consisting of papers of glass, polybenzimidazole and polybenzoxazole.

17. An electrolyte according to claim 16, wherein the substrate is selected from the group consisting of polybenzimidazole and polybenzoxazole.

18. An electrolyte according to claim 16, wherein the membrane further comprises a binder.

19. An electrolyte according to claim 18, wherein the binder comprises a polymeric binder having a weight average molecular weight ranging from about 40,000 to about 500,000.

20. An electrolyte according to claim 18, wherein the binder comprises a polymer quaternizable to form a material selected from the group consisting of hydrogen sulfate, hydrogen phosphate, sulfonic acid salts of aromatic polyetheretherketone, and sulfonic acid salts of aromatic polyether sulfone.

21. An electrolyte according to claim 18, wherein the binder is selected from the group consisting of poly-4-vinyl pyridine hydrogen phosphate, poly-4-vinyl pyridine hydrogen sulfate, poly-2-methyl-5-vinyl pyridine hydrogen phosphate, poly-2-methyl-5-vinyl pyridine hydrogen sulfate, sulfonic acid salts of aromatic polyetheretherketone, and sulfonic acid salts of aromatic polyether sulfone.

22. An electrolyte for use in a fuel cell, the electrolyte comprising:
a membrane comprising:
a quantity of particles of a sulfonated-organosilica hybrid electrolyte material having the general formula: 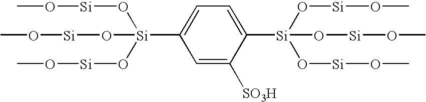
and
a quantity of Teflon® latexes.

23. An electrolyte according to claim 22, wherein the Teflon® latexes are present in an amount ranging from about 3 to about 13 wt %.

24. An electrolyte according to claim 22, wherein the Teflon® latexes are present in an amount ranging from about 3 to about 10 wt %.

25. An electrolyte according to claim 22, wherein the Teflon® latexes are present in an amount ranging from about 5 to about 6 wt %.

26. A fuel cell comprising:
an anode;
a cathode; and
an electrolyte comprising:
a membrane comprising:
a quantity of particles of a sulfonated-organosilica hybrid electrolyte material having the general formula: 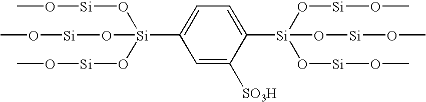
and
a carrier for carrying said particles.

27. A fuel cell according to claim 26, wherein the carrier comprises Nafion®.

28. A fuel cell according to claim 27, wherein the sulfonated-organosilica hybrid electrolyte particles are suspended in a solution of Nafion®, and Nafion® is present in the solution in an amount ranging from about 10 to about 80 wt %.

29. A fuel cell according to claim 26, wherein the carrier is a substrate selected from the group consisting of papers of glass, polybenzimidazole and polybenzoxazole.

30. A fuel cell according to claim 26, wherein the carrier is a substrate selected from the group consisting of papers, polybenzimidazole and polybenzoxazole.

31. A fuel cell according to claim 29, wherein the membrane further comprises a binder.

32. A fuel cell according to claim 31, wherein the binder comprises a polymeric binder having a weight average molecular weight ranging from about 40,000 to about 500,000.

33. A fuel cell according to claim 31, wherein the binder comprises a polymer quaternizable to form a material selected from the group consisting of hydrogen sulfate, hydrogen phosphate, sulfonic acid salts of aromatic polyetheretherketone, and sulfonic acid salts of aromatic polyether sulfone.

34. A fuel cell according to claim 31, wherein the binder is selected from the group consisting of poly-4-vinyl pyridine hydrogen phosphate, poly-4-vinyl pyridine hydrogen sulfate, poly-2-methyl-5-vinyl pyridine hydrogen phosphate, poly-2-methyl-5-vinyl pyridine hydrogen sulfate, sulfonic acid salts of aromatic polyetheretherketone, and sulfonic acid salts of aromatic polyether sulfone.

35. A fuel cell according to claim 26, wherein the carrier comprises a quantity of Teflon® latexes.

36. A fuel cell according to claim 35, wherein the Teflon® latexes are present in an amount ranging from about 3 to about 13 wt %.

37. A fuel cell according to claim 35, wherein the Teflon® latexes are present in an amount ranging from about 3 to about 10 wt %.

38. A fuel cell according to claim 35, wherein the Teflon® latexes are present in an amount ranging from about 5 to about 6 wt %.

39. A fuel cell comprising:
an anode;
a cathode; and
an electrolyte comprising:
a membrane comprising:
a quantity of particles of a sulfonated-organosilica hybrid electrolyte material having the general formula: 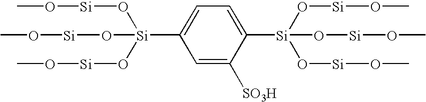
and
a quantity of Nafion®.

40. An electrolyte according to claim 39, wherein the sulfonated-organosilica hybrid electrolyte particles are suspended in a solution of Nafion®, and Nafion® is present in the solution in an amount ranging from about 10 to about 80 wt %.

41. A fuel cell comprising:
an anode;
a cathode; and
an electrolyte comprising:
a membrane comprising:
a quantity of particles of a sulfonated-organosilica hybrid electrolyte material having the general formula: 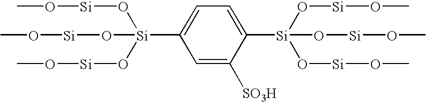
and
a substrate selected from the group consisting of papers of glass, polybenzimidazole and polybenzoxazole.

42. A fuel cell according to claim 41, wherein the substrate is selected from the group consisting of papers, polybenzimidazole and polybenzoxazole.

43. A fuel cell according to claim 41, wherein the membrane further comprises a binder.

44. A fuel cell according to claim 43, wherein the binder comprises a polymeric binder having a weight average molecular weight ranging from about 40,000 to about 500,000.

45. A fuel cell according to claim 43, wherein the binder comprises a polymer quaternizable to form a material selected from the group consisting of hydrogen sulfate, hydrogen phosphate, sulfonic acid salts of aromatic polyetheretherketone, and sulfonic acid salts of aromatic polyether sulfone.

46. A fuel cell according to claim 43, wherein the binder is selected from the group consisting of poly-4-vinyl pyridine hydrogen phosphate, poly-4-vinyl pyridine hydrogen sulfate, poly-2-methyl-5-vinyl pyridine hydrogen phosphate, poly-2-methyl-5-vinyl pyridine hydrogen sulfate, sulfonic acid salts of aromatic polyetheretherketone, and sulfonic acid salts of aromatic polyether sulfone.

47. A fuel cell comprising:
an anode;
a cathode; and
an electrolyte comprising:
a membrane comprising:
a quantity of particles of a sulfonated-organosilica hybrid electrolyte material having the general formula: 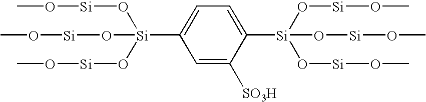
and
a quantity of Teflon® latexes.

48. A fuel cell according to claim 47, wherein the Teflon® latexes are present in an amount ranging from about 3 to about 13 wt %.

49. A fuel cell according to claim 47, wherein the Teflon® latexes are present in an amount ranging from about 3 to about 10 wt %.

50. A fuel cell according to claim 47, wherein the Teflon® latexes are present in an amount ranging from about 5 to about 6 wt %.

51. A method of forming the electrolyte of claim 22, the method comprising:
suspending the quantity of sulfonated-organosilica hybrid electrolyte material and the quantity of Teflon® latexes in solution;
co-precipitating the sulfonated-organosilica hybrid electrolyte materials and the Teflon® latexes forming a co-precipitate of sulfonated-organosilica hybrid electrolyte materials and Teflon®; and
forcing the co-precipitate through a narrow passage between a first roller and a second roller.

52. A method according to claim 51, wherein when the co-precipitate is forced through the narrow passage, the quantity of Teflon® forms an irregular non-woven fibrous structure comprising a plurality of holes, and wherein forcing the co-precipitate through the narrow passage forces particles of the sulfonated-organosilica hybrid electrolyte material into the holes in the Teflon® structure.

53. A method according to claim 51, further comprising repeating the forcing the co-precipitate through the narrow passage step until the co-precipitate forms a uniform membrane having no holes.

54. A method of forming the electrolyte of claim 16, the method comprising:
mixing the quantity of sulfonated-organosilica hybrid electrolyte material with the binder;
applying the mixture to the substrate to form a membrane construction; and
smoothing the construction.

55. A method according to claim 54, wherein when the construction is smoothed, particles of the sulfonated-organosilica hybrid electrolyte material are forced into holes in the substrate.

56. A method of forming the electrolyte of claim 14, the method comprising:
suspending the quantity of sulfonated-organosilica hybrid electrolyte material and the quantity of Nafion® in a solution mixture; and
solution casting the solution mixture.
